(19) United States
(12) Patent Application Publication
(10) Pub. No.: US 2005/0061723 A1
(43) Pub. Date: Mar. 24, 2005

(54) Filter unit

(75) Inventor: Yoshiharu Matsushita, Sashima-gun (JP)

Correspondence Address: OLIFF & BERRIDGE, P.O. BOX 19928, ALEXANDRIA, VA, 22320, US

(73) Assignee: KYOSAN DENKI CO., LTD., Sashima-gun (JP)

(21) Appl. No.: 10/934,482

(22) Filed: Sep. 7, 2004

(30) Foreign Application Priority Data
Sep. 19, 2003 (JP) 2003-327092

(51) Int. Cl. B01D 35/00

(52) U.S. Cl. 210/171; 210/335; 210/416.4

(57) ABSTRACT

A filter assembly includes a filter element having an internal space and an annular member, one end of which being placed within the internal space of the filter element, the other end of which being placed outside of the same space. The filter assembly is then mounted in a case by connecting the other end of the annular member to an inlet or outlet of the case.

### INCORPORATION BY REFERENCE

The disclosure of Japanese Patent Application No. 2003-327092 filed on Sep. 19, 2003 including the specification, drawings and abstract is incorporated herein by reference in its entirety.

### BACKGROUND OF THE INVENTION

1. Field of the Invention

The present invention relates to a filter unit. More specifically, it relates to a filter unit obtained through a simplified manufacturing process.

2. Description of the Related Art

A known filter unit for removing foreign matter in fuel is provided upstream or downstream of a fuel pump in a motor vehicle. With strong demands for reduction in the weight and cost of each motor vehicle part or component, various measures have also been taken for such fuel filter units.

As one example of such a cost and weight reduced filter unit, the applicant has proposed a filter unit indicated in FIGS. 16 to 18, which includes a filter element that is able to be manufactured without adhesive, and therefore in a simplified manufacturing process (see Japanese Laid Opened Patent Application No. 2002-282626).

Referring to FIGS. 16 to 18, a filter element 1 has a three-layer structure including a coarse layer 1b formed of non-woven fabric and serving as a passage portion through which fuel just passes, a fine layer 1a formed of non-woven fabric and serving as a filtering portion for removing foreign matter in fuel, and another coarse layer 1b formed of non-woven fabric and serving as said passage portion. The filter element 1 is folded (or two pieces of the filter element 1 are placed on the top of other) such that a V-shaped filter 2 having an opening 3 in one side is formed, and a filter assembly 5 is obtained by rolling the V-shaped filter 2 around a core 4 as shown in FIG. 17.

In this case, however, the opposite surfaces of the coarse layer 1b must be bonded by thermal welding, or the like, before rolled around the core 4. The portion of the V-shaped filter 2 shown in the left side in FIG. 17 is before rolled and the potion in the right side is after rolled.

Thermal welding is performed using an iron 6. The iron 6 has a forked tip including heating portions 6a at the inner sides facing each other and non-heating portions 6b at the outer sides. When welding the filter element 1, the iron 6 is made to sandwich the upper end of one internal portion of the V-shaped filter 2 and the upper end of another portion of the V-shaped filter 2 facing that portion, and the iron 6 is then moved circularly about the core 4 as indicated by an arrow R in FIG. 16. Thus, the filter element 5 is welded so that the openings 3 and welded portions 7 are alternately lined up as viewed from above. It is to be noted that there is substantially no clearance at each opening 3 while FIG. 18 shows some.

Subsequently, the filter element 5 is fit into a case 8 having a fuel inlet 9 and a fuel outlet 10, whereby a fuel filter unit A is obtained. Fuel flows through the fuel inlet 9 into the case 8 and passes through the coarse layer 1b at the opening 3 in the upper side of the filter element 5 and the fine layer 1a in which foreign matter is removed. After filtered at the fine layer 1a, the fuel passes through the coarse later 1b in the other side and flows out via the fuel outlet 10.

In this fuel filter unit A, however, the outer surface of the filter element 5 needs to be bonded to the inner surface of the case 8 to prevent unfiltered fuel from passing through the fuel filter unit A.

Meanwhile, referring to FIG. 17, because the filter element 5 is formed by rolling the filter element 1, a step 11 having width h is unavoidably formed at the end of the filter element 1. This step 11 creates a clearance between the outer surface of the filter assembly 5 and the internal surface of the case 8, therefore it is feared that fuel before filtered may be leaked to the downstream side. To prevent this, a known method eliminates the clearance by applying adhesive 12 between the outer surface of the filter element 5 and the internal surface of the case 8, as shown in FIG. 18, rather than bonding them directly.

The use of the adhesive 12 however requires at least one applying process in the manufacturing procedure and additional material cost for the adhesive 12, thereby increasing the total manufacturing cost accordingly. Also, care must be taken to ensure a sufficient bonding (sealing) quality since adhesive usually hardens depending on the temperature and humidity or through chemical reaction between base material and hardening agent. Furthermore, in recent years, polyacetal resin has been increasingly used as material for such a case owing to its relatively low cost and high swellability. However, polyacetal resin involves a problem that its adhesive applicability is low, and therefore the filter assembly can only be fixed with low adhesiveness.

### SUMMARY OF THE INVENTION

In view of the above problems, the invention has been made to provide a filter unit which is able to be manufactured by fixing a filter assembly into a case without adhesive, thus achieving simplified manufacturing process and reduced cost.

To accomplish the above object, a first aspect of the invention relates to a filter unit for removing foreign matter in flowing body which includes a filter assembly and a case for containing the filter assembly. The filter assembly include (i) a filter element two surfaces of which are attached so that an internal space is formed between them, the filter element being rolled or folded into a specific shape, and (ii) an annular member through which the flowing body flows into or out of the filter assembly. One end of the annular member is placed within the internal space of the filter element, while the other end of the annular member is placed outside of the same internal space. The case has a case inlet through which the flowing body flows into the case and a case outlet through which the flowing body flows out from the case. Either the case inlet or the case outlet is in communication with the other end of the annular member of the filter assembly.

According to the above structure, the filter assembly is able to be fixed to the case simply by connecting the other end of the annular member to the case inlet or the case outlet irrespective of the state of abutment between the outer surface of the filter assembly and the internal surface of the case. Accordingly, the need of adhesive is eliminated and installation of the filter assembly into the case is simplified, thus reducing the production cost.

A second aspect of the invention relates to a filter unit for removing foreign matter in flowing body, which includes a filter assembly and a case for containing the filter assembly. The filter assembly includes (i) two filter elements attached so that an internal space is formed between the two surfaces of the filter element, the filter elements being together rolled or folded into a specific shape, and (ii) an annular member through which the flowing body flows into or out of the filter assembly. One end of the annular member is placed within the internal space between the filter elements, while the other end of the annular member is placed outside of the same internal space. The case has a case inlet through which the flowing body flows into the case and a case outlet through which the flowing body flows out from the case, either the case inlet or the case outlet being in communication with the other end of the annular member of the filter assembly.

According to this structure, the same advantages and effects as the first aspect of the invention are able to be obtained.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a perspective view showing a filter element having three layers;

FIG. 2 is a sectional view showing another filter element having a fine layer consisting of two or more sub layers;

FIG. 3A and FIG. 3B are views showing another filter element having dimples;

FIG. 4 is a sectional view showing a filter assembly in a first exemplary embodiment before being rolled up;

FIG. 5 is a front view of the filter assembly shown in FIG. 4;

FIG. 6 is a perspective view showing the filter assembly shown in FIG. 4 after rolled up;

FIG. 7 is a sectional view showing a filter assembly in a second exemplary embodiment before folded up;

FIG. 8 is a front view of the filter assembly shown in FIG. 7;

FIG. 9 is a perspective view showing the filter assembly shown in FIG. 7 after folded up;

FIG. 10 is a perspective view showing a filter assembly in a third exemplary embodiment after folded up;

FIG. 11 a perspective view showing another form of the filter assembly in the third exemplary embodiment after folded up;

FIG. 12A and FIG. 12B are views showing an annular member used for the filter assembly shown in FIGS. 10, 11;

FIG. 13 is a sectional view showing a filter unit according to the invention;

FIG. 14 is a sectional view showing another filter unit according to the invention;

FIG. 15 is a sectional view showing another filter unit according to the invention when installed downstream of a fuel pump;

FIG. 16 is a sectional view for illustrating a manufacturing method for a known filter unit;

FIG. 17 is a perspective view schematically showing the known filter unit;

FIG. 18 is a sectional view showing the filter unit in FIG. 17; and

FIG. 19 is a view showing another exemplary installation of the filter unit.

### DETAILED DESCRIPTION OF THE PREFERRED EMBODIMENTS

Exemplary embodiments of the invention will be described with reference to the accompanying drawings. First of all, it is to be noted that while the invention has been embodied as a flitter device provided downstream of a fuel pump in a motor vehicle in each exemplary embodiment the invention is not limited to such use in a motor vehicle.

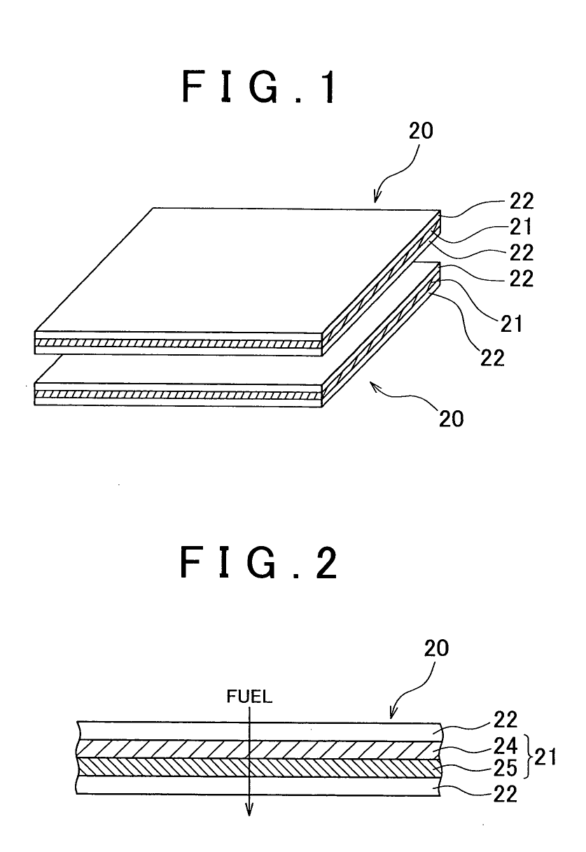

A first exemplary embodiment will hereinafter be described. Referring to FIG. 1, a filter element 20 is formed as a three-layer filter element including a fine non-woven fabric 21 (fine layer) generally serving as a filter portion and coarse non-woven fabrics 22 (coarse layers) provided in both sides of the fine non-woven fabric 21 and each generally serving as a passage portion through which fuel passes.

The filter element 20 is folded so that two surfaces thereof are attached. To obtain such a form of the filter element 20, one filter element 20 may be folded at the center to lay one side on the other as in this embodiment, or two filter elements 20 may instead be layered on each other, for example. Thus, fuel is made to flow through the coarse layer 22, the fine layer 21, and another coarse layer 22.

Also if non-woven fabric made of polyester, polypropylene, rayon, acetate, or the like, is used as material for the filter element 20, it would become easier to bond the filter element 20 by thermal welding, or the like.

FIG. 2 shows another form of the filter element 20 having a four-layer structure in which the fine layer 21 consists of a low density layer 24 and a high density layer 25. According to this structure, large matter is caught by the low density layer 24 and small matter by the high density layer 25, thus resulting in a relatively high efficiency in removing foreign matter.

In this structure, fuel passes through one of the coarse layers 22, the low density layer 24, the high density layer 25, and the other of the coarse layers 22. While the fine layer 21 include two sub-layers in this example, it may include more than two sub-layers arranged in such an order that the filter density increases along with the fuel flow direction. Accordingly, such a multi-layered filter element may also be used to form the filter element 20. Hereinafter, a filter assembly 35 refers to a filter assembly constituted by the filter element 20 and an annular member 26, while a fuel filter unit A refers to a fuel filter unit including the filter assembly 35 and other necessary components.

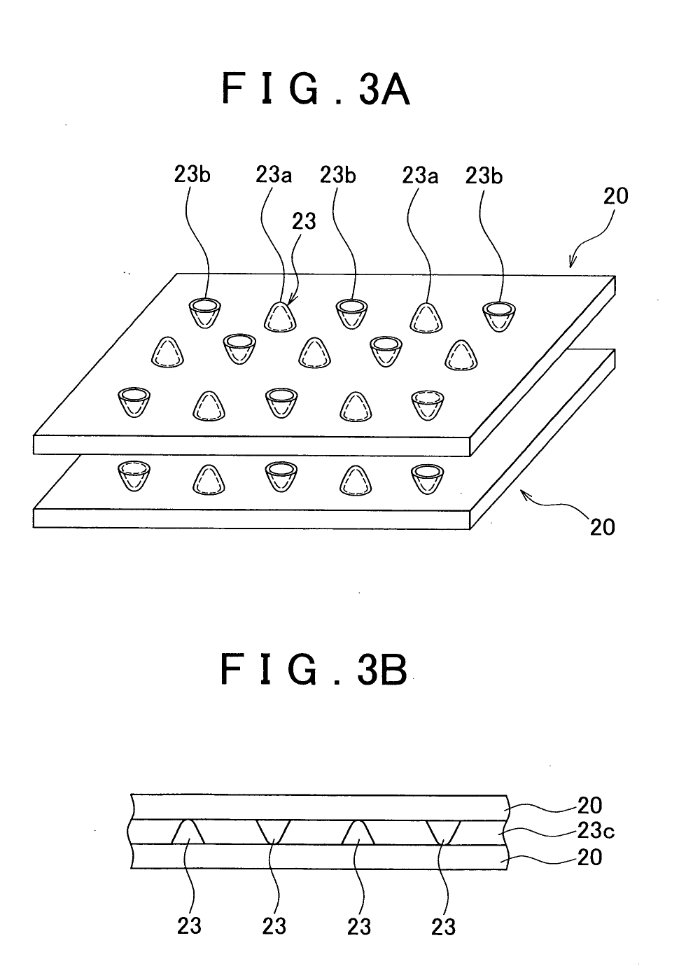

In the meantime, it is conceivable that, when the two surfaces of the filter element 20 are attached as aforementioned, the space for allowing fuel to flow inside the 20 may be insufficient. To counter this, in this exemplary embodiment, convex and concave dimples 23 are formed on the opposite internal surfaces in the filter element 20 (see FIG. 3A). More specifically, convex dimples 23a and concave dimples 23b are alternately formed on each internal surface of the filter element 20. With the dimples 23, a fuel passage 23c is formed between the two surfaces of the filter element 20 when they are attached (see FIG. 3B). While the dimples 23 are formed on both internal surfaces of the filter element 20 in this exemplary embodiment, they may only be formed on one of the internal surfaces. Also, the filter element 20 may contain resin material so that it becomes easier to bond by thermal welding, or the like. Note that the dimples 23 may be formed in various shapes such as a round shape, linear shape.

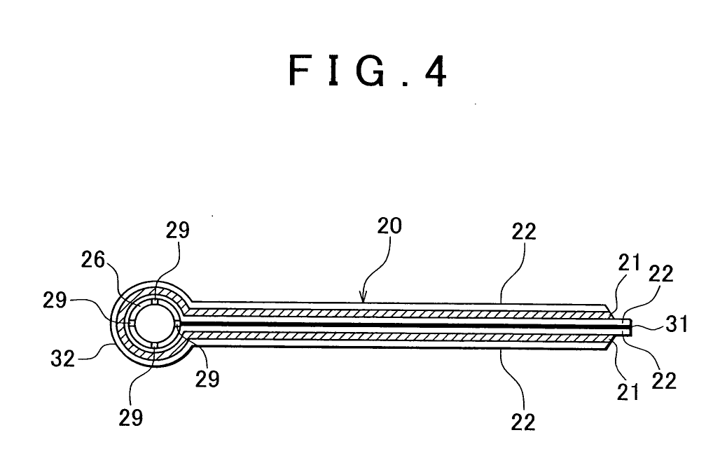

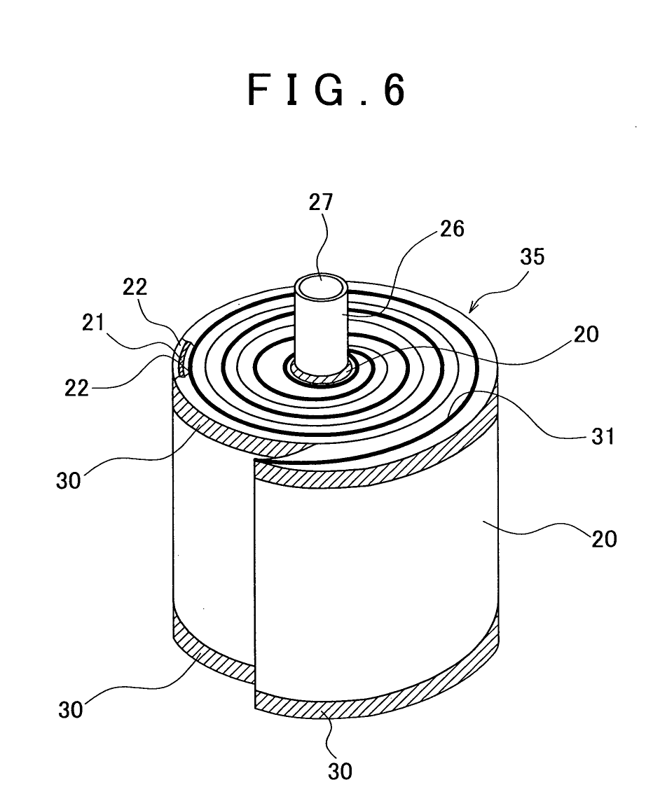

In the first exemplary embodiment, referring to FIG. 6, the filter element 20 is rolled around the annular member 26, thus forming the filter assembly 35. The procedure for assembling the filter assembly 35 will hereinafter be described in detail with reference to FIGS. 4 to 6.

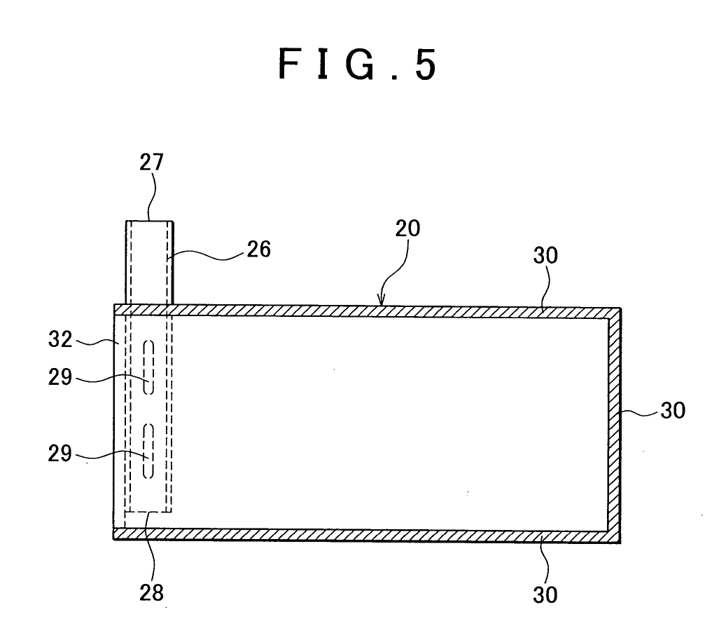

In the first exemplary embodiment, the filter element 20 formed of three layers and having an elongated rectangular shape, shown in FIG. 1, is used. The filter element 20 is folded and one side thereof is placed on the other, so that a folded portion 32 (shown in the left side in FIG. 5) is formed.

The annular member 26 is made of resin and has an upper opening 27 and a lower opening 28. A plurality of side holes 29 for facilitating the flow of fuel are formed substantially in the lower side of the annular member.

The annular member 26 is fit into the filter element 20 along the folded portion 32 in such a way that the side holes 29 are located in the filter element 20 while the upper portion of the filter element 20 projects upward from the upper end of the filter element 20. The two attached surfaces of the filter element 20 are then firmly bonded along the remaining three sides by thermal welding, or the like, and the filter element 20 and the annular member 26 are firmly bonded together at their contact portions in the same manner.

As a result, a space 31 is formed in the filter element 20 which leads to the outside via the lower opening 28, the side holes 29, and the upper opening 27. It is understood that there is substantially no clearance at the space 31 while the drawings show some. According to this structure, fuel passes through the coarse layers 22 on both sides. To facilitate the flow of fuel towards the space 31, the side holes 29 may be made face towards the space 31 or the opening area of the side hole(s) 29 facing the space 31 may be made larger than others.

The filter element 20 is then rolled around the annular member 26 as a core to provide the filter assembly 35 shown in FIG. 6. The filter element 20 is fastened by a band, or the like, to be retained in the rolled form. The filter assembly 35 is installed into a case 40, to be described later, via the upper projecting portion of the annular member 26.

Having the foregoing structure, the filter assembly 35 works both in a case in which fuel enters the filter assembly 35 from the peripheral portion of the filter element 20 and flows out via the upper opening 27 of the annular member 26, and in a case in which fuel enters the filter assembly 35 from the upper opening 27 of the annular member 26 and flows out via the peripheral portion of the filter element 20

While the filter assembly 35 has been formed by rolling the filter element 20 around the annular member 26, the filter element 20 may instead be rolled about one end portion of the filter element 20 (rightmost end portion in FIG. 5) opposite to the other end portion in which the annular member 26 is located. In this case, the center portion of the filter assembly 35 is formed by part of the filter element 20 and the annular member 26 is located at the circumference of the filter element 20 after rolled.

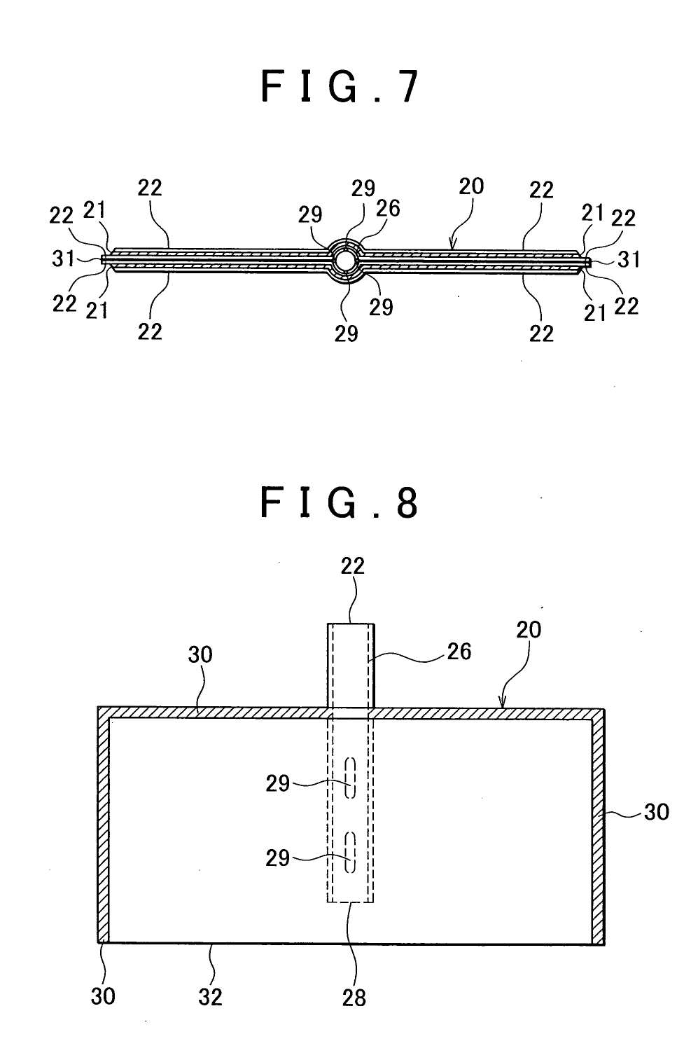

Next, a second exemplary embodiment of the invention will be described with reference to FIGS. 7 to 9. The filter element 20 having three layers (see FIG. 1) is also used in this embodiment. The filter element 20 is folded at the center and one side thereof is placed on the other, thus forming a folded portion 32 which is located at the lower end of the filter element 20 in FIG. 8.

The annular member 26 shown in FIGS. 4 to 6 is also used in this embodiment. The annular member 26 is inserted into the center portion of the filter element 20 folded as aforementioned, perpendicularly with respect to the folded portion 32 such that the side holes 29 are located in the filter element 20 while the upper portion of the filter element 20 projects upward from the filter element 20. The two surfaces of the filter element 20 are then firmly bonded along the remaining three sides by thermal welding, or the like, and the filter element 20 and the annular member 26 are firmly bonded together at their contact portions in the same manner.

Accordingly, left and right spaces 31 are formed in the filter element 20 each leading to the outside via the lower opening 28, the side holes 29, and the upper opening 27. It is understood that there is substantially no clearance at each space 31 while the drawing shows some. According to this structure, fuel passes through the coarse layers 22 on both sides. To facilitate the flow of fuel towards the space 31, as in the first exemplary embodiment, the side holes 29 may be made face towards the space 31 or the opening area of the side hole(s) 29 facing the space 31 may be made larger than others.

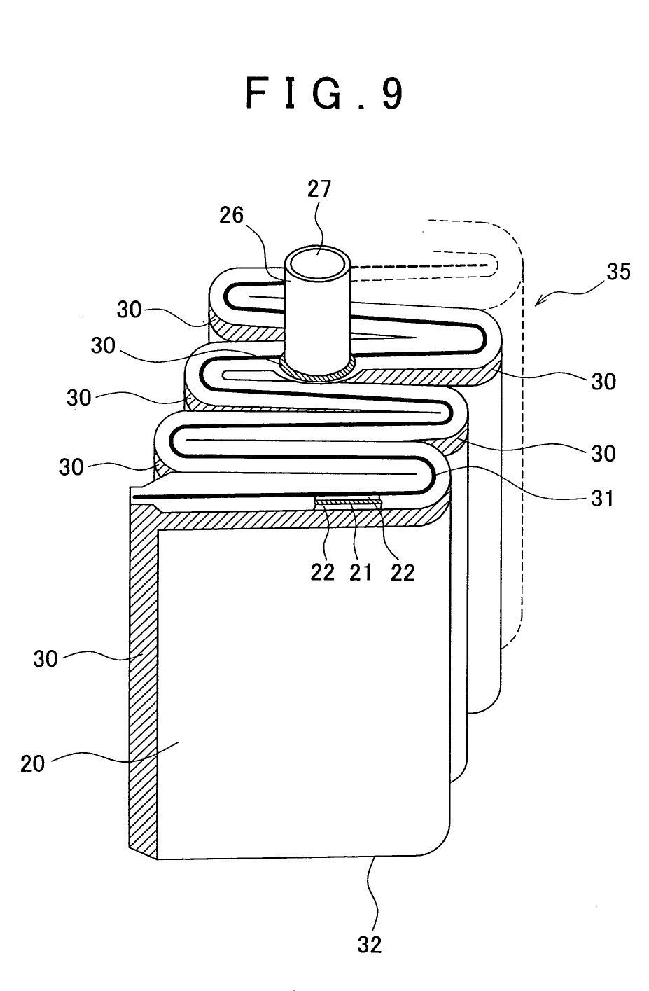

Then, referring to FIG. 9, the left and right portions of the filter element 20 are folded a few times such that each fold line is in parallel to the axis of the annular member 26 and each folded surface of the filter element 20 extends in the right-left direction substantially symmetrically about the annular member 26. The filter element 20 is then fastened by a band, or the like, to be retained in the folded form.

Having the foregoing structure, the filter assembly 35 works both in a case in which fuel enters the filter assembly 35 from the peripheral portion of the filter element 20 and flows out via the upper opening 27 of the annular member 26, and in a case in which fuel enters the filter assembly 35 from the upper opening 27 of the annular member 26 and flows out through the peripheral portion of the filter element 20

In the second exemplary embodiment, too, the non-woven fabric shown in FIG. 2 in which the fine layer includes two or more sub-layers may be used as the filter element 20. Also, the filter paper having the dimples 23 shown in FIG. 3A, FIG. 3B may be used instead. In this case, however, if attached filter papers are folded multiple times as in the second exemplary embodiment, a filter paper having the dimples 23 on both sides, not on either side, is preferably used because none of the dimples 23 will otherwise be present between some of the attached surfaces of the filter element 20.

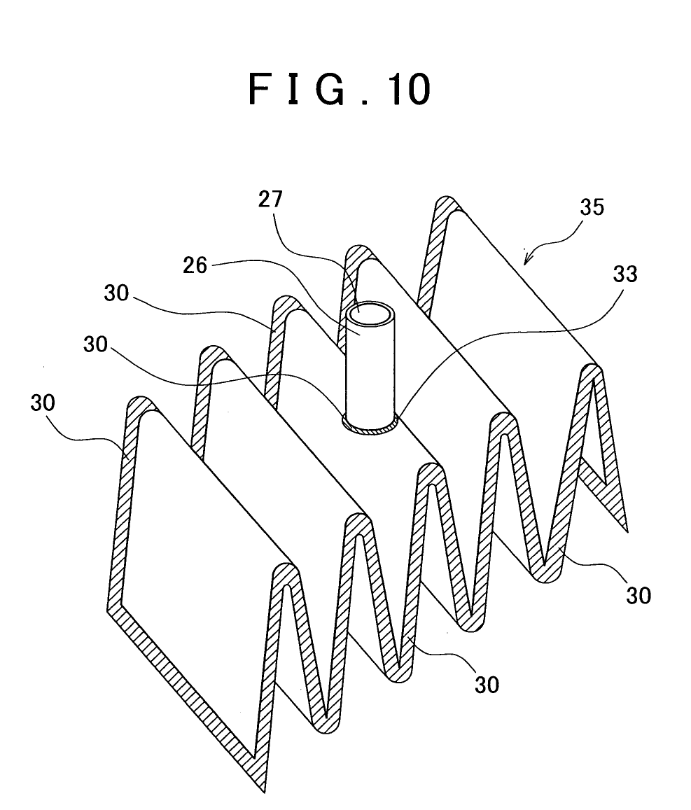

Next, a third exemplary embodiment will be described with reference to FIGS. 10 to 12. The filter element 20 shown in FIG. 1 having three layers is also used in this embodiment. In this exemplary embodiment, two elongated pieces of the filter element 20 are attached and an opening 33 into which the annular member 26 will be inserted is formed at the center of the upper piece of the filter element 20.

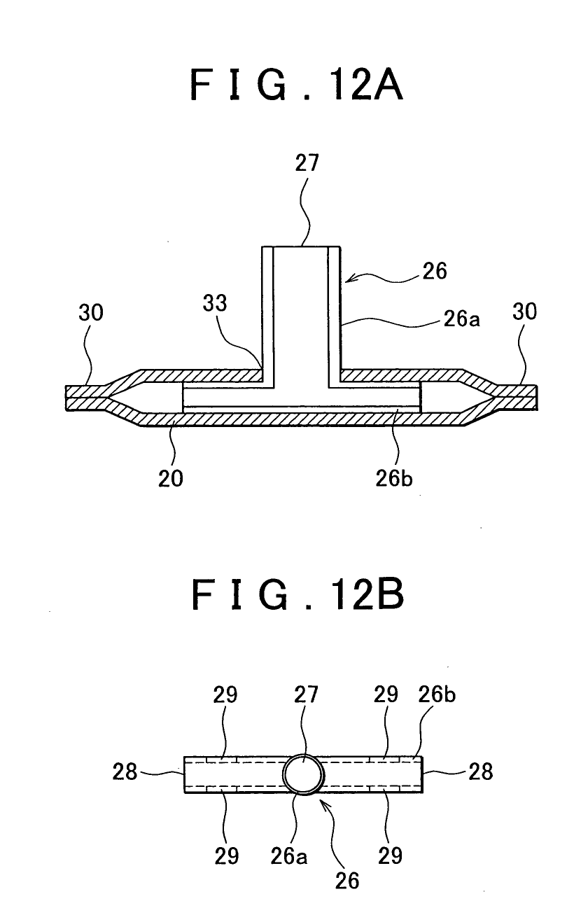

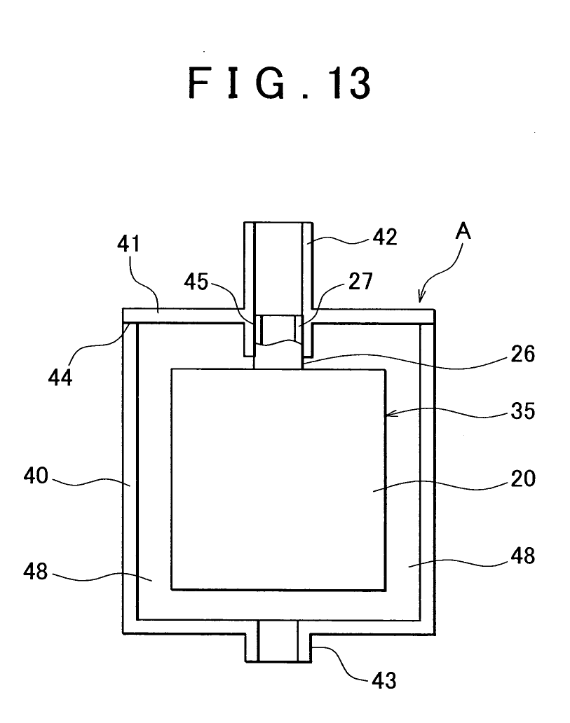

In the third exemplary embodiment, referring to FIGS. 12A, 12B, the annular member 26 is constituted by a vertical pipe 26a and a lateral pipe 26b joined into the shape of “T” and has an upper opening 27 in the top of the vertical pipe 26a, two lower openings 28 at both ends of the lateral pipe 26b, and a plurality of side holes 29 formed in the side wall of the lateral pipe 26b in order to facilitate the flow of fuel.

The annular member 26 is fit into the filter element 20 such that the vertical pipe 26a is projected upwards through the opening 33 formed at the center of the upper piece of the filter element 20 and the lateral pipe 26b extends in parallel to the lateral direction of the annular member 26. Then, the upper and lower pieces of the filter element 20 are firmly bonded along all sides by thermal welding, or the like, and the vertical pipe 26a is firmly bonded to the inner periphery of the opening 33 in the same manner.

As a result, a space 31 is formed in the filter element 20 which leads to the outside via the lower opening 28 and the side holes 20 of the annular member 26. Also in this exemplary embodiment, to facilitate the flow of fuel towards the space 31, the side holes 29 may be made face towards the space 31 or the opening area of the side hole(s) 29 facing the space 31 may be made larger than others.

Then, the right and left portions of the filter element 20 are folded several times such that each fold line is in parallel to the axis of the annular member 26 and each folded surface of the filter element 20 extends in the right-left direction substantially symmetrically about the annular member 26. The filter element 20 is then fastened by a band, or the like, to be retained in the folded form.

In the third exemplary embodiment, too, the non-woven fabric shown in FIG. 2 in which the fine layer includes two or more sub-layers may be used as the filter element 20. Also, the filter paper having the dimples 23 shown in FIG. 3A, FIG. 3B may be used instead. In this case, however, if attached filter papers are folded multiple times as in the third exemplary embodiment, it is noted that a filter paper having the dimples 23 on both sides, not on either side, is preferably used because none of the dimples 23 will otherwise be present between some of the attached surfaces of the filter element 20.

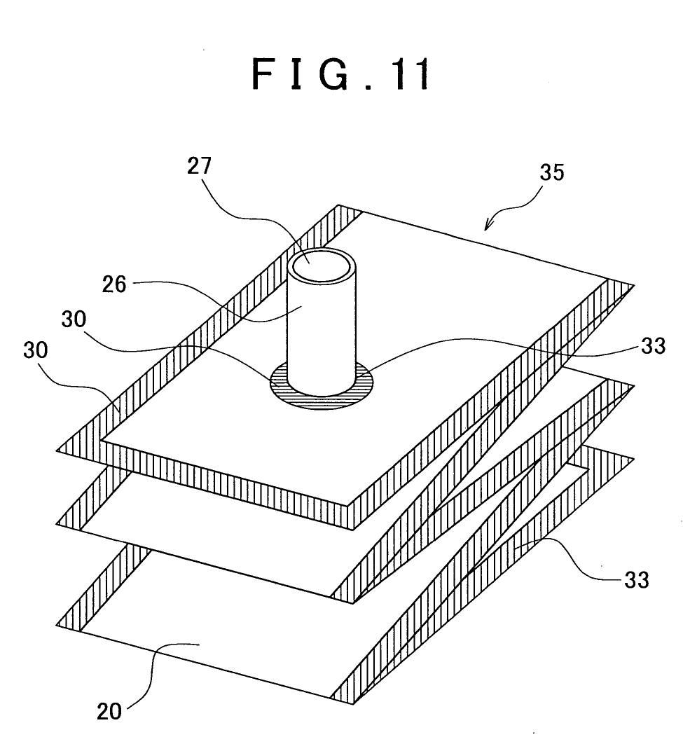

FIG. 11 illustrates another form of the third exemplary embodiment. In this example, the filter element 20 is folded several times and the opening 33 is formed in one end portion of the upper piece of the filter element 20

In this case, too, the annular member 26 shown in FIGS. 12A, 12B is used, and it is fit into the filter element 20 such that the vertical pipe 26a projects upward from the opening 33 formed in the one end of the filter element 20 and the lateral pipe 26b extends in parallel to the lateral direction of the filter element 20 Then, the upper and lower pieces of the filter element 20 are firmly bonded along all sides by thermal welding, or the like, and the vertical pipe 26a is firmly bonded to the inner periphery of the opening 33 in the same manner.

As a result, a space 31 is formed in the end portion of the filter element 20 which leads to the outside via the side holes 29, the lower opening 28, and the upper opening 27 of the annular member 26. Also in this exemplary embodiment, to facilitate the flow of fuel towards the space 31, the side holes 29 may be made face towards the space 31 or the opening area of the side hole(s) 29 facing the space 31 may be made larger than others.

Then, the filter element 20 is folded several times from one end thereof such that each fold line is in parallel to the axis of the lateral pipe 26b and the folded surfaces of the filter element 20 are lined up in the vertical direction under the annular member 26. The filter element 20 is then fastened by a band, or the like, to be retained in the folded form.

In this case, too, the non-woven fabric shown in FIG. 2 in which the fine layer includes two or more layers may be used as the filter element 20. Also, the filter paper having the dimples 23 shown in FIG. 3A, FIG. 3B may be used instead. In this case, however, if attached filter papers are folded multiple times as in the third exemplary embodiment, it is noted that a filter paper having the dimples 23 on both sides, not on either side, is preferably used because none of the dimples 23 will otherwise be present between some of the attached surfaces of the filter element 20.

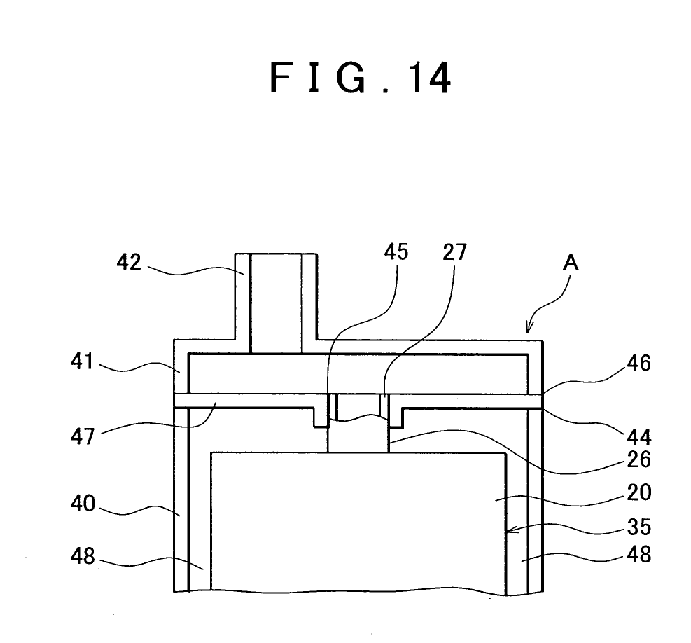

FIGS. 13 and 14 each show a fuel filter unit A obtained by installing the filter assembly 35 into a case 40. Referring to FIG. 13, the filter assembly 35 is directly placed in the case 40 which is a cylindrical case opened at the upper side thereof, and a cap 41 having an upper pipe portion 42 is placed on the case 40. A lower pipe portion 43 is integrally formed in the bottom of the case 40.

The filter assembly 35 is installed in the case 40 in the following procedure, for example. The annular member 26 of the filter assembly 35 is inserted into the upper pipe portion 42 of the cap 41 from the bottom side, and the annular member 26 and the upper pipe portion 42 are bonded at their contact portions. Then, the cap 41 to which the filter assembly 35 has been fixed as above is then placed on the case 40 so as to cover the upper opening of the case 40, and the upper end of the case 40 and the bottom surface of the cap 41 are bonded by thermal welding, or the like. Thus, a space 48 for facilitating the flow of fuel is formed between the output surface of the filter assembly 35 and the inner surface of the case 40.

While in the above example the case 40 and the cap 41 have been described as separate components, they may together be regarded as the case. Meanwhile, having the foregoing structure, the fuel filter unit A works both in a case in which fuel enters 40 from the upper pipe portion 42 and flows out via the annular member 26, the filter element 20, and the lower pipe portion 43, and in a case in which the fuel flows in reverse.

Another form of the fuel filter unit A is shown in FIG. 14. In this example, a flange 47 formed by a flat plate having an outer diameter generally equal to the case 40 is provided and the filter assembly 35 is installed to the case 40 via the flange 47. For example, the filter assembly 35 (i.e., the annular member 26) and the flange 47 may either be bonded together at their contact portions by thermal welding, or the like, or may just be molded together.

The flange 47 is placed on the case 40 to cover the upper opening of the case 40, and the cap 41, which has been formed to have a concave shape in section in this example, is then placed on the top of the flange 47. Subsequently, the bottom surface of the flange 47 and the upper end of the case 40 are bonded by thermal welding, or the like, and so are the top surface of the flange 47 and the lower end of the cap 41.

Accordingly, since the filter assembly 35 is fixed to the case 40 via the flange 47, the annular member 26 and the upper pipe portion 42 are not necessarily positioned in line with each other, therefore the upper pipe portion 42 is able to be easily formed at a desired position with respect to the cap 41, increasing its design freedom. While in the above example the case 40 and the cap 41 have been described as separate components, they may together be regarded as the case.

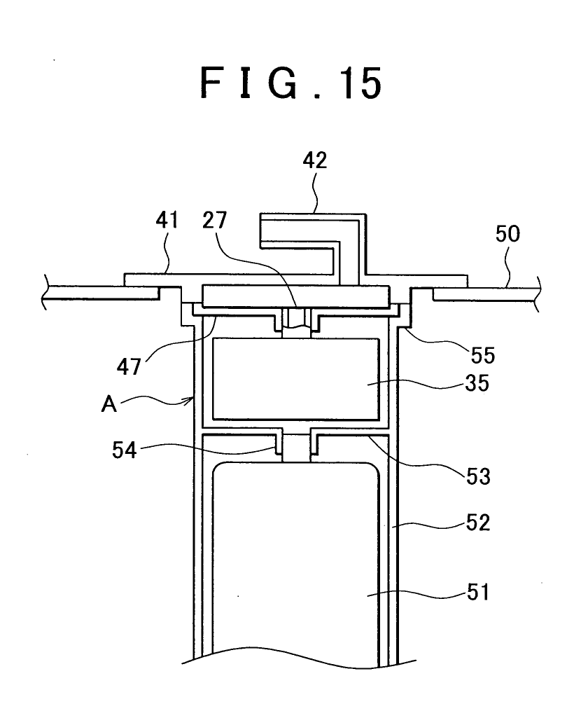

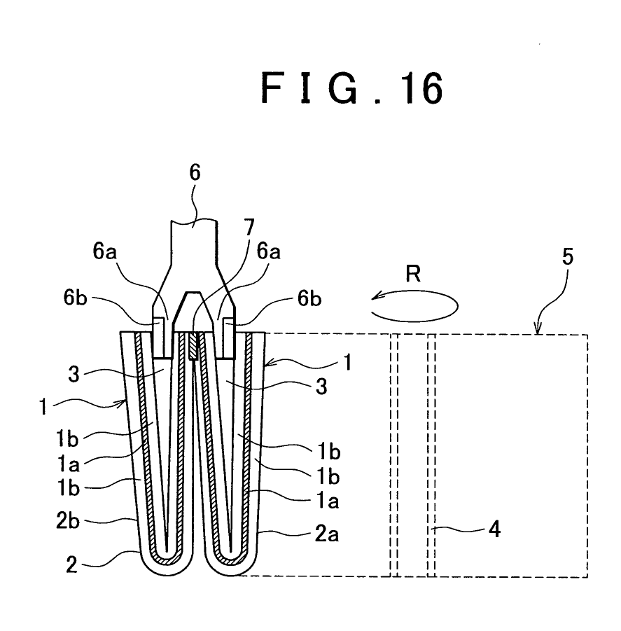

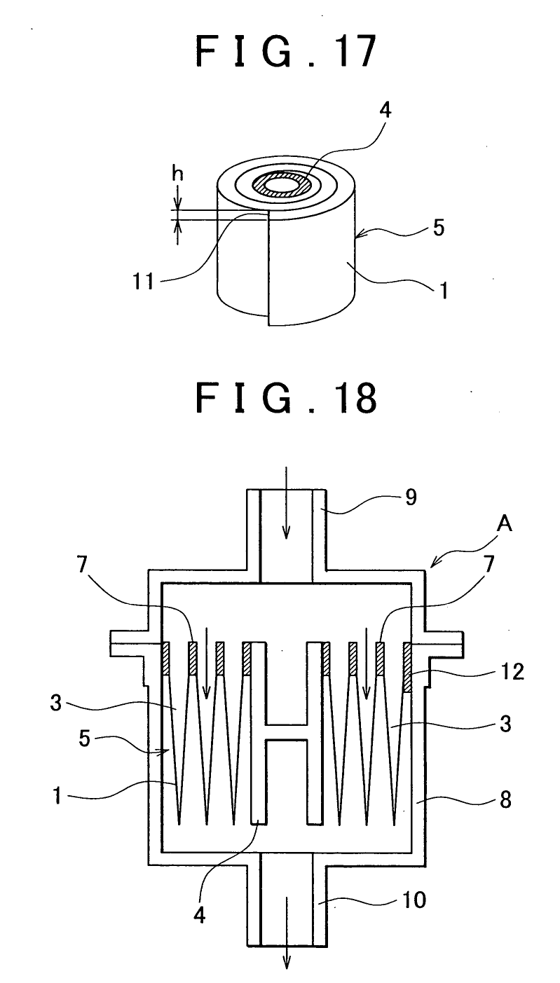

FIG. 15 shows one example of installation of the fuel filter unit A in a gasoline engine. In this example, a filter pump 51 is provided in a fuel tank 50 and the fuel filter unit A is installed downstream of the fuel pump 51. More specifically, the fuel pump 51 is mounted in a case 52, and the fuel filter unit A is installed in the upper area of the case 52 partitioned by a plate 53.

The fuel pump 51 is connected to an opening 54 of the plate 53, the rim of which projects downward. The flange 47 to which the filter assembly 35 has been fixed as mentioned above is then sandwiched at its circumference between the upper end of the case 52 and the lower end of the cap 41 and the cap 41 having the upper pipe portion 42 is placed on the top of the fuel tank 50.

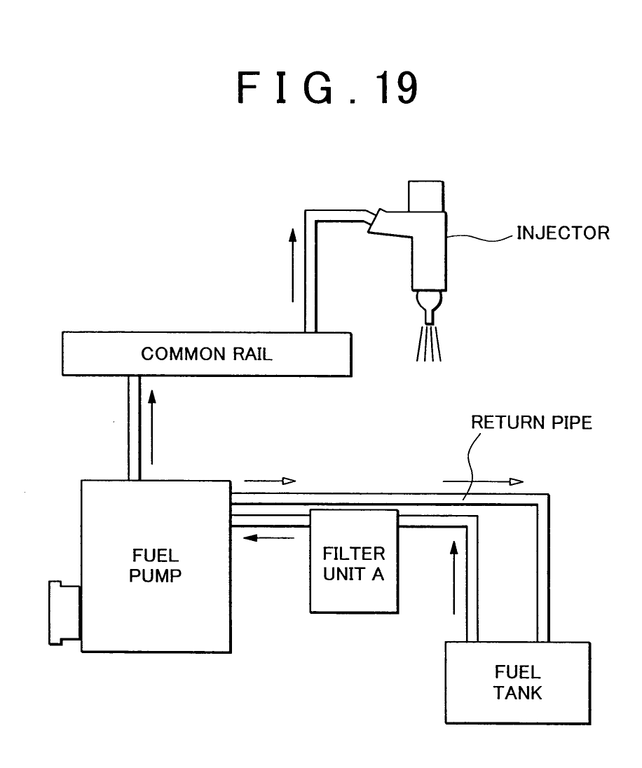

According to this structure, fuel pumped up from the fuel tank 50 by the fuel pump 51 is made to flow through the opening 54 into the fuel filter unit A located downstream of the fuel pump 51. After filtered by the fuel filter unit A, the fuel then flows out from the tank 50 via the upper opening 27 and the upper pipe portion 42. While the fuel filter unit A is installed in the fuel tank 50 in this example, it may instead be provided outside of the fuel tank 50. In the foregoing structure, the filter unit A according to the invention has been applied to a gasoline engine in which the filter unit A is provided downstream of the fuel pump 51, the filter unit A may instead be used in, for example, a diesel engine and provided upstream of a fuel tank, as shown in FIG. 19.

Also, motor vehicle application does not limit at all the scope of the invention, but the invention may be embodied as a filter unit for other use. Namely, while the invention has been described with reference to preferred embodiments thereof, it is to be understood that the invention is not limited to the preferred embodiments or constructions. To the contrary, the invention is intended to cover various modifications and equivalent arrangements other than described above. In addition, while the various elements of the preferred embodiments are shown in various combinations and configurations, which are exemplary, other combinations and configurations, including more, less or only a single element, are also within the spirit and scope of the invention.

1. A filter unit for removing foreign matter in flowing body, comprising:
a filter assembly including (i) a filter element two surfaces of which are attached so that an internal space is formed between the two surfaces of the filter element, the filter element being rolled or folded into a specific shape, and (ii) an annular member through which the flowing body flows into or out of the filter assembly, one end of the annular member being placed within the internal space of the filter element, the other end of the annular member being placed outside of the same internal space; and
a case for containing the filter assembly, which has a case inlet through which the flowing body flows into the case and a case outlet through which the flowing body flows out from the case, either the case inlet or the case outlet being in communication with the other end of the annular member of the filter assembly.

2. A fuel filter unit according to claim 1, wherein
the filter element is made of non-woven fabric including a fine layer serving as a filter portion and two coarse layers provided in both sides of the fine layer and each serving as a passage portion through which the flowing body passes.

3. A fuel filter unit according to claim 2, wherein
the fine layer includes a first sub-layer having a specific density and a second sub-layer having a density greater than the first sub-layer's density, and the first sub-layer is located upstream of the second sub-layer.

4. A fuel filter unit according to claim 1, wherein
the filter element is a filter paper having concave or convex portions on at least one side thereof.

5. A fuel filter unit according to claim 4, wherein
the filter paper contains resin.

6. A fuel filter unit according to claim 1, wherein
the other end of the annular member is either fixedly connected to the case inlet or the case outlet.

7. A fuel filter unit according to claim 1, wherein
the other end of the annular member is fixed to the case via a flange.

8. A fuel filter unit according to claim 1, wherein
the fuel filter unit is provided downstream of a fuel pump in a motor vehicle.

9. A filter unit for removing foreign matter in flowing body, comprising:
a filter assembly including (i) two filter elements attached so that an internal space is formed between the filter elements, the filter elements being together rolled or folded into a specific shape, and (ii) an annular member through which the flowing body flows into or out of the filter assembly, one end of the annular member being placed within the internal space between the filter elements, the other end of the annular member being placed outside of the same internal space; and
a case for containing the filter assembly, which has a case inlet through which the flowing body flows into the case and a case outlet through which the flowing body flows out from the case, either the case inlet or the case outlet being in communication with the other end of the annular member of the filter assembly.

10. A fuel filter unit according to claim 9, wherein
at least one of the filter elements is made of non-woven fabric including a fine layer serving as a filter portion and two coarse layers provided in both sides of the fine layer and each serving as a passage portion through which the flowing body passes.

11. A fuel filter unit according to claim 10, wherein
the fine layer includes a first sub-layer having a specific density and a second sub-layer having a density greater than the first sub-layer's density, and the first sub-layer is located upstream of the second sub-layer.

12. A fuel filter unit according to claim 9, wherein
at least one of the filter elements is a filter paper having concave or convex portions on at least one side thereof.

13. A fuel filter unit according to claim 12, wherein
the filter paper contains resin.

14. A fuel filter unit according to claim 9, wherein
the other end of the annular member is either fixedly connected to the case inlet or the case outlet.

15. A fuel filter unit according to claim 9, wherein
the other end of the annular member is fixed to the case via a flange.

16. A fuel filter unit according to claim 9, wherein
the fuel filter unit is provided downstream of a fuel pump in a motor vehicle.

17. A fuel filter unit according to claim 1, wherein
the fuel filter unit is provided upstream of a fuel pump in a motor vehicle.

18. A fuel filter unit according to claim 9, wherein
the fuel filter unit is provided upstream of a fuel pump in a motor vehicle.
